(19) United States
(12) Patent Application Publication
(10) Pub. No.: US 2025/0379734 A1
(43) Pub. Date: Dec. 11, 2025

(54) Enhanced RSA Algorithm Using Transform Function

(71) Applicants: Shubham P. Ladhe, Apex, NC (US); Pankaj S. Ladhe, Apex, NC (US)

(72) Inventors: Shubham P. Ladhe, Apex, NC (US); Pankaj S. Ladhe, Apex, NC (US)

(21) Appl. No.: 18/734,210

(22) Filed: Jun. 5, 2024

(51) Int. Cl. H04L 9/30; H04L 9/06; H04L 9/08

(52) U.S. Cl. CPC H04L 9/302; H04L 9/0618; H04L 9/0825; H04L 9/3073

(57) ABSTRACT

The present disclosure relates to a security enhancement to the RSA algorithm, referred to as Ladhe's Algorithm, that vastly increases security without increasing key length. This security enhancement is achieved by obfuscating the modulus n through a reliable and reversible method to eliminate the possibility of factorization attacks. In embodiments of the present disclosure, the security of RSA is enhanced without increasing the key length by applying a mathematical function, referred to herein as the transform function fₜ, to the prime number p and q, to obtain a pseudo modulus S that is distributed in place of the real modulus n with the public key. The pseudo modulus S has two parts: a code associated with the transform function and a value derived from p and q. The code serves as an index to a table or other data structure that maps the code to a particular transform function. The transform function is known only to a trusted agent (TA). Only the TA is able to derive the real modulus n from the pseudo modulus S.

### TECHNICAL FIELD

The present disclosure relates generally to asymmetric cryptosystems using a public-private key pair and, more particularly to an enhanced RSA (Rivest-Shamir-Adleman) algorithm that increases security by eliminating the distribution of the modulus n with the public key.

### BACKGROUND

RSA (Rivest-Shamir-Adleman) is an asymmetric key cryptosystem that uses two distinct but related keys to securely send a message. In RSA, each participant generates a public-private key pair. The public key can be freely distributed and is used for encryption, while the private key, which must be kept secret, is used for decryption. The sender uses the public key to convert readable plaintext to unreadable ciphertext that is transmitted to the recipient, i.e., to encrypt the message. The recipient uses the private key to decode the ciphertext and convert it back to plaintext, i.e., to decrypt the message.

In RSA, public and private keys are derived from two large prime numbers p and q that are multiplied to obtain a modulus n. The modulus n is exposed as part of the public key (e, n). The security of the RSA algorithm relies on the difficulty of factoring n. However, if a malicious third party is able to factor n to obtain the prime factors p and q, known as a factorization attack, the security of the RSA algorithm is compromised.

The security of RSA can be increased by increasing the key length to make factorization attacks more difficult. The commonly recommended key length for RSA encryption is 2048 bits for medium security and 4096 bits for high security. In practical terms, this means that the prime numbers used in RSA encryption should have roughly half the length of the desired key size. For example, for a 2048-bit RSA key, the prime numbers should each be approximately 1024 bits long. These key lengths provide a good balance between security and computational efficiency.

However, as computational power increases over time, longer key lengths may not be sufficient to maintain the same level of security. The life expectancy of RSA encryption is diminishing rapidly due to advancements in quantum computers that have the potential to factor very large numbers, thus making RSA more susceptible to factorization attacks. If RSA becomes insecure, the entire security framework of the Internet would be compromised with potentially disastrous and wide-ranging consequences. Some of the potential consequences include:
Data Breaches: Hackers could gain unauthorized access to sensitive data stored on servers such as personal information, financial data, intellectual property, and more.
Identity Theft: With access to personal data, cybercriminals could engage in identity theft, using stolen information to impersonate individuals for fraudulent activities such as opening bank accounts, applying for loans, or making purchases.
Financial Losses: Businesses and individuals could suffer financial losses due to cyber attacks, including theft of funds, ransom demands, or disruption of financial services.
Disruption of Services: Critical infrastructure and essential services relying on the Internet, such as power grids, transportation systems, healthcare facilities, and communication networks, could be disrupted, leading to widespread chaos and potential safety risks.
Loss of Trust: A compromised security framework could undermine trust in online services, leading to decreased user confidence in conducting transactions, sharing information, or engaging in online activities.
Escalation of Cyber Warfare: Nation-states or state-sponsored actors could exploit vulnerabilities in the Internet's security framework to launch cyber attacks against other countries, leading to geopolitical tensions and potential conflicts.
Impact on Economy: The economy could suffer due to the costs associated with mitigating cyber threats, restoring systems after attacks, and lost productivity resulting from disruptions to businesses and services.
Social Unrest: If essential services such as healthcare, emergency response, or communication systems are affected, it could lead to social unrest and public dissatisfaction with government and institutions.

Accordingly, there is a need to improve the security of the RSA algorithm to avoid existential threats to the security framework upon which everyone relies.

### SUMMARY

The present disclosure relates to a security enhancement to the RSA algorithm, referred to as Ladhe's Algorithm, that vastly increases security without increasing key length. This security enhancement is achieved by obfuscating the modulus Il through a reliable and reversible method to eliminate the possibility of factorization attacks. In embodiments of the present disclosure, the security of RSA is enhanced without increasing the key length by applying a mathematical function, referred to herein as the transform function fₜ, to the prime number p and q, to obtain a pseudo modulus S that is distributed in place of the real modulus n with the public key. The pseudo modulus S has two parts: a code associated with the transform function and a value derived from p and q. The code serves as an index to a table or other data structure that maps the code to a particular transform function. The transform function is known only to a trusted agent (TA). Only the TA is able to derive the real modulus n from the pseudo modulus S.

To encrypt a message, the sender sends an encryption request to the TA including the plaintext message M along with the public key. Upon receipt of the encryption request, the TA calculates the modulus n from the pseudo modulus S, encrypts the plaintext message M according to conventional RSA, and returns the ciphered message to the sender. The sender transmits the ciphered message C to the recipient. When the recipient receives the encrypted message, the recipient sends a decryption request to the TA including the ciphered message C and its private key. The TA calculates the modulus n from the pseudo modulus S, decrypts the ciphered message according to conventional RSA, and returns the ciphered message to the sender.

Ladhe's Algorithm thwarts factorization attacks by eliminating the distribution of the real modulus n. Instead, the modulus Il is encapsulated in the pseudo modulus S. Without knowledge of the transform function, a malicious third party has no feasible way to determine n. But the number of potential transformations that can be applied to obscure n makes it virtually impossible to derive the modulus n especially when combined with regular key updates.

Also, by preventing factorization attacks, the life expectancy of RSA is extended without the need for longer keys, which would increase computational complexity and latency. Thus, Ladhe's Algorithm can help prevent the security framework of the Internet from being compromised, which could result is disastrous consequences.

### BRIEF DESCRIPTION OF THE DRAWINGS

FIG. 1 is a signaling flow for key generation and distribution according to an embodiment.

FIG. 2 is a signal flow for encryption and decryption according to an embodiment.

FIG. 3A is a flow chart showing a method of key generation and distribution using Ladhe's Algorithm.

FIG. 3B is a flow chart showing a method implemented in a computing device for a trusted agent of encrypting a plaintext message using Ladhe's Algorithm

FIG. 3C is a flow chart showing a method implemented in a computing device for a trusted agent of decrypting a ciphered message using Ladhe's Algorithm.

FIG. 4 is a flow chart showing a method of encrypting data using Ladhe's Algorithm.

FIG. 5 is a flow chart showing a method of using Ladhe's Algorithm to decrypt a message.

FIG. 6 is a functional block diagram of a computing device configured to implement the cryptographic algorithms herein described.

### DETAILED DESCRIPTION

The RSA algorithm uses two distinct but related keys to securely send a message. A public key that can be freely distributed is used for encryption, while a private key, which must be kept secret, is used for decryption. The sender of a message uses the public key to convert readable plaintext to unreadable ciphertext that is transmitted to the recipient, i.e. to encrypt the message. The recipient uses the private key to decode the ciphertext and convert it back to plaintext, i.e. to decrypt the message.

In RSA, the public and private keys are derived from two large prime numbers as follows:
Choose two distinct prime number p and q.
Compute the product, n=p×q, which serves as the modulus for both the public and private keys.
Calculate Euler's totient function ϕ(n)=(p−1)(q−1), which gives the count of positive integers less than n that are coprime with n.
Choose an integer e such that 1<e<ϕ(n) and e is coprime with ϕ(n). This is the public exponent.
Compute the modular multiplicative inverse d of e modulo ϕ(n) according to d=e⁻¹(mod ϕ(n)). This is the private exponent.

The public key is the public exponent e and modulus n, i.e., k_{pub}=pub =(e,n) The private key is the private exponent d and the modulus n, i.e., kₚᵣ=(d, n). The prime numbers p and q, modulus n and totient ϕ(n) must be kept secret because these values can be used to calculate d.

A plaintext message M is encrypted with the public key according to:

$$C = {M}^{e} mod ( n ) ,$$

where C is the ciphered message. The ciphered message C is decrypted using the private key according to:

$$M = {C}^{d} mod ( n )$$

Secure communication according to the RSA Algorithm involves five main processes:
1. Key Generation. The owner, or TA, generates a pair of RSA keys—a public key and a private key. These keys are mathematically related in such a way that data encrypted with one key can only be decrypted with the other.
2. Public Key Publication. Once generated, the public key is published or made available to anyone who wants to send encrypted messages to the owner of the key. This could be done through various means such as a public key server, a website, or even directly shared with specific individuals.
3. Validation and Authentication:. It is important for users to verify that the public key they receive actually belongs to the intended recipient and hasn't been tampered with or spoofed. This can be done through digital signatures, certificate authorities, or other means of trust verification.
4. Encryption. Once a user has obtained and verified the recipient's public key, it can be used to encrypt messages intended for that recipient. Encryption with the public key ensures that only the recipient, who possesses the corresponding private key, can decrypt and access the original message.
5. Decryption. The recipient decrypts the ciphered message with its private key, which must be kept a secret. RSA is not secure if the private key is compromised.

The exposure of the modulus n as part of the public key (e, n) poses a security risk in RSA. Security is compromised if a malicious third party is able to factor the modulus Il to obtain the prime factors p and q. The commonly recommended key length for RSA encryption is 2048 bits for medium security and 4096 bits for high security. However, as computational power increases over time, longer key lengths may be necessary to maintain the same level of security.

The present disclosure relates to a security enhancement to the RSA algorithm, referred to as Ladhe's Algorithm, that vastly increases security without increasing key length. This security enhancement is achieved by obfuscating the modulus n through a reliable and reversible method to eliminate the possibility of factorization attacks. According to embodiments of the present disclosure, the security of RSA is enhanced without increasing the key length by applying a mathematical function, referred to herein as the transform function fₜ, to the prime numbers p and q (or alternatively to the modulus n) to obtain a pseudo modulus S that is distributed in place of the real modulus n with the public key. The pseudo modulus S has two parts: a code associated with the transform function and a value derived from p and q. The transform function is known only to a trusted agent (TA) so the TA only is able to derive the real modulus n from the pseudo modulus S.

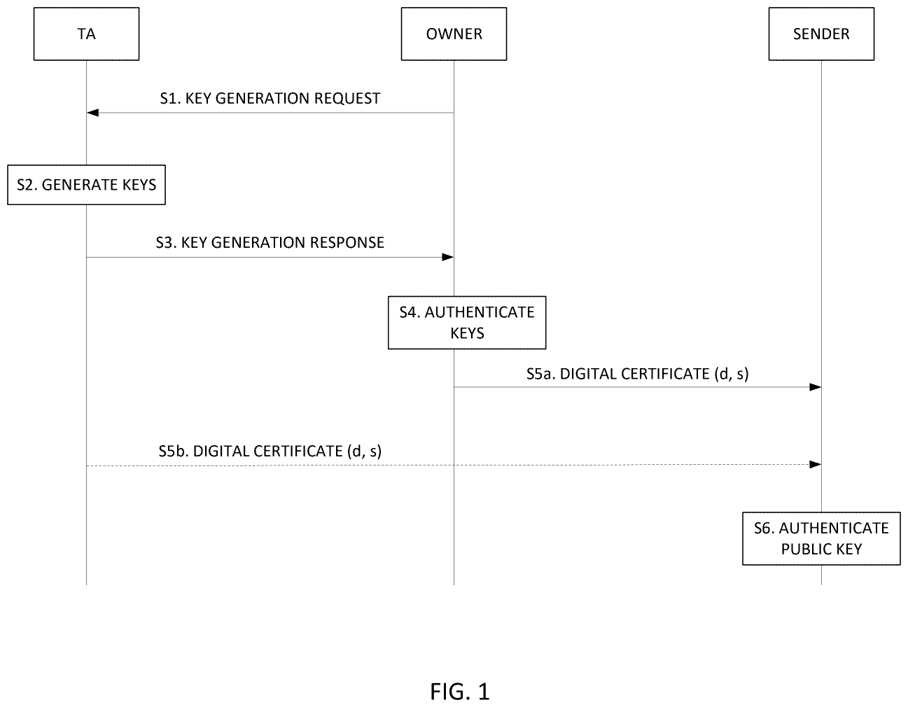

FIG. 1 illustrates key generation and distribution using Ladhe's Algorithm. Key generation begins when the owner sends a key generation request to the TA (S1). In response to the key generation request, the TA generates a key pair including a public key and a private key (S2). After the keys are generated, the TA sends the keys to the owner in a digital certificate (S3). In some embodiments, the owner may verify the TA as the source of the digital certificate using known verification methods (S4). If the source of the keys is verified, the owner can share the key with others by sending its digital certificate (S5a). The digital certificate shared in this step includes the public key but does not include the private key. Alternatively, the TA may share the digital certificate upon request from others (S5b). Before using the public key, a sender should authenticate the public key to make sure that it belongs to the owner/intended recipient of the message (S6).

Any known method of trust verification can be used in steps S4 and S6 to authenticate the keys, such as digital signatures and certificate authorities. For example, when sharing the public key, the owner of the public key can create a digital signature for the public key using the private key. This signature is essentially a unique cryptographic checksum generated from the public key and encrypted with the private key. It provides a way to verify that the public key hasn't been tampered with and that it indeed belongs to the claimed owner. Certificate authorities can also be used to verify the authenticity of public keys. Because techniques for verification of the public keys are well-known and are not material to the present disclosure, Further description of various verification methods is omitted herein for the sake of brevity.

In one embodiment, key generation (S2) is performed by the TA as follows:
Choose two distinct prime number p and q.
Calculate Euler's totient function ϕ(n)=(p−1)(q−1), which gives the count of positive integers less than nl that are coprime with n.
Choose an integer [symbol] such 1< [symbol] <ϕ(n) and e is coprime with ϕ(n). This is the public exponent.

Compute the modular multiplicative inverse d of [symbol] modulo ϕ(n) according to d= [symbol] ⁻¹(mod ϕ(n)). This is the private exponent.
Compute substitute modulus l′ by applying transform function

$${f}_{i}^{T}$$

to p and q, i.e.,

$$v = {f}_{i}^{T} ( p , q ) ,$$

where i is an index associated with the transform function. Note that the transform function is reversible and has a corresponding reverse transform function

$${f}_{i}^{R}$$

that can be used to derive the real modulus n from value v.
Combine index i with value v to obtain pseudo modulus S.

The public key is the public exponent e and pseudo modulus S, i.e., K_{pub}=(e, s) The private key is the private exponent d and the pseudo modulus S, i.e., kₚᵣ=(d, s).

As earlier described, the TA provides the public and private keys to the owner. The private key is maintained as a secret by the key owner. The owner can publish the public key or otherwise distribute the public key to others. The public key can also be distributed by a public key server, which could be operated by the TA.

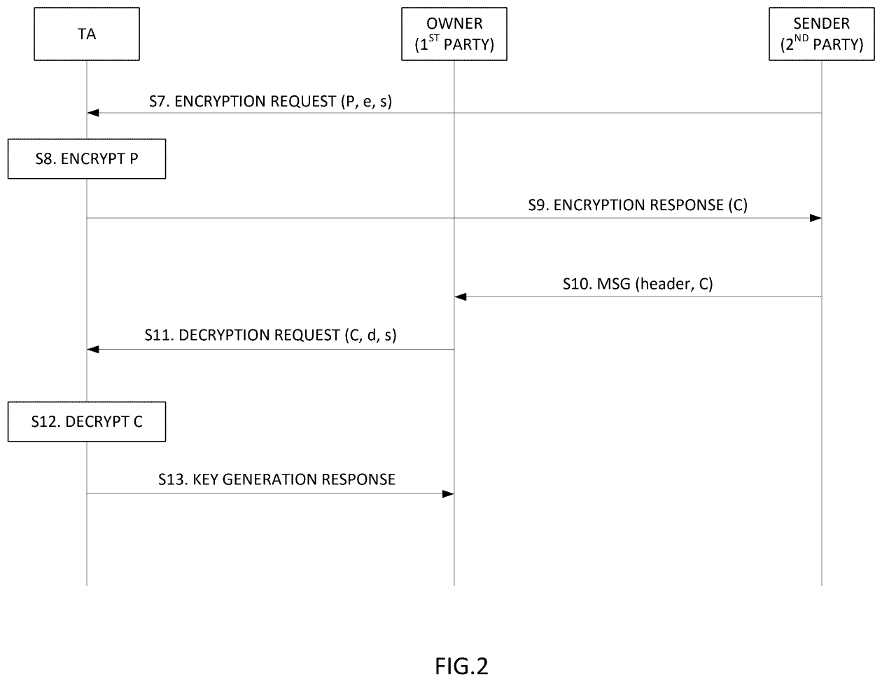

As in conventional RSA, the public key is used to encrypt messages intended for the owner of the key. When a message is encrypted or decrypted, software installed on the user's device, such as a browser or dedicated application, communicates with the TA to perform the encryption and/or decryption. FIG. 2 illustrates encryption and decryption of a message sent from a sender to the owner of the key. Note that the numbering of the message exchange continues from FIG. 1.

FIG. 2 is a signaling flow illustrating encryption and decryption using Ladhe's Algorithm. When a sender wants to send a message securely to the owner/recipient, an application on the sender's device sends an encryption request to the TA over a secure connection (S7). The connection may use known protocols such as Secure Shell (SSH), or Secure Socket Layer-Transport Layer Security (SSL-TLS) to enable the application to communicate securely with the TA. The encryption request includes the plaintext message M and the encryption key (e, s). When an encryption request is received, the TA encrypts the plaintext message M and returns a ciphered message C to the sender in an encryption response (S8, S9).

In one embodiment, encryption is performed by the TA at step S8 as follows:
Extract index i and value v from pseudo modulus S.
Determine the reverse transform function

$${f}_{i}^{R} .$$

Apply reverse transform function to value v to obtain n, i.e.,

$$n = {f}_{i}^{R} ( v )$$

Encrypt the plaintext message M using conventional RSA encryption algorithm to generate the ciphered message C, i.e., C= [symbol] mod(n)

The sender transmits the ciphered message C returned by the TA at step S9 to the intended recipient in a message MSG (S10). The ciphered message C is included in the payload of the message and a header is appended including the source and destination addresses for routing the message to the intended recipient. The header is unencrypted.

Returning to FIG. 2, when an encrypted message is received, the owner/recipient sends a decryption request to the TA over a secure connection (S11). As previously noted, the connection may use known protocols such as Secure Shell (SSH), or Secure Socket Layer-Transport Layer Security (SSL-TLS) to enable the application to communicate securely with the TA. The decryption request includes the ciphered message C extracted from the message payload, and the private key (d, s). When a decryption request is received, the TA decrypts the ciphered message C and returns the plaintext message M to the owner/recipient in a encryption response (S12, S13).

In one embodiment, decryption is performed by the TA at step S12 as follows:
Extract index i and value v from pseudo modulus S.
Determine reverse transform function

$${f}_{i}^{R} .$$

Apply reverse transform function to value v to obtain n, i.e.,

$$n = {f}_{i}^{R} ( v )$$

Decrypt message using conventional RSA encryption algorithm to generate plaintext message M, i.e., M=C^{d} mod(n)

Several simplified examples of the transform function and reverse transform function are given below to demonstrate the basic principle of Ladhe's Algorithm.

### Example 1

In a first example, assume that P=5 and q=101. In this case, the modulus n is:

$$\begin{matrix}n = p \times q \\ = 5 \times 105 \\ = 505\end{matrix}$$

The totient ϕ(n) is:

$$\begin{matrix}ϕ ( n ) = ( p - 1 ) ( q - 1 ) \\ = ( 5 - 1 ) ( 101 - 1 ) \\ = 400\end{matrix}$$

The public and private exponents are derived using conventional RSA. The public exponent e is any integer greater than 1 and coprime with ϕ(n)=400. In this example, e=17 is chosen. The private exponent d can be found using the extended Euclidean algorithm:

$$d = {e}^{- 1} ( mod ϕ ( n ) )$$

Given e=17 and ϕ(n)=400 in this example, d=53.

In conventional RSA, the public key is (e, n) and the private key is (d ,n). To avoid distribution of the modulus n, a pseudo modulus s is calculated and used in place of the modulus n as the public and private keys. The pseudo modulus s is calculated by applying a transform function

$${f}_{i}^{T} ( p , q )$$

with p and q as inputs to derive a value v, which is combined with the index i associated with the transform function. The mapping between the index i and transform function

$${f}_{i}^{T} ( p , q )$$

is kept secret by the TA. In this example, assume that the transform function is given by:

$${f}_{i}^{T} ( p , q ) = {p}^{2} \times {q}^{2}$$

where the index i=0001. Given p=5 and q=101, the value v is:

$$\begin{matrix}v = {p}^{2} \times {q}^{2} . \\ = {5}^{2} \times {101}^{2} \\ = 255025\end{matrix}$$

The pseudo modulus s is obtained by combining i and v. For simplicity, the pseudo modulus s in this example is assumed to be the concatenation of i and v or 0001255025. The pseudo modulus s is substituted for the real modulus n is the public and private keys so the public key becomes (e, s) and the private key becomes (d, s).

The owner receives the private key from the TA and the public key is shared with others that want to communicate securely with the owner. To encrypt a message intended for the owner, the sender sends an encryption request to the TA including the plaintext message M, the public exponent e and the pseudo modulus s The TA calculates the ciphered message C and returns the ciphered message C to the sender. The communication between the sender and TA is over a secure connection.

To encrypt the plaintext message M, the TA first needs to determine the real modulus n from the pseudo modulus s contained In the encryption request. The real modulus n is obtained by extracting v from s and applying a reverse transform function

$${f}_{i}^{R} ( v )$$

to v. The TA uses a secret mapping between i and

$${f}_{i}^{R} ( v )$$

to determine the correct function to apply. In this example, the reverse transform function

$${f}_{i}^{R} ( v )$$

is given by:

$${f}_{i}^{R} ( v ) = \sqrt{v} = n$$

Given v=255025, n is calculated to be 505. Once n is obtained, the conventional RSA encryption is applied to encrypt the plaintext message M. To complete this example, the ciphered message C is given by:

$$C = {M}^{e} mod ( n )$$

Assuming that the message M=65, the ciphered message C=320.

A similar process is used to decrypt the ciphered message C. When the owner receives the encrypted message, the owner sends a decryption request to the TA including the ciphered message C contained in the message, the private exponent d and the pseudo modulus s The TA calculates the plaintext message M and returns the decrypted plaintext message M to the owner. The communication between the owner and TA is over a secure connection.

To decrypt the ciphered message C, the TA first needs to determine the real modulus n from the pseudo modulus s contained In the encryption request. The real modulus n is obtained as previously described by extracting v from s and applying the reverse transform function

$${f}_{i}^{T} ( v )$$

to v. As described above, applying the reverse transform function yields n=505. Once n is obtained, the conventional RSA encryption is applied to decrypt the ciphered message. To complete this example, the plaintext message M is given by:

$$M = {C}^{d} mod ( n )$$

Assuming that the ciphered message C=320, the message M is calculated to be 65.

### Example 2

In a second example, an arbitrary number is selected whose remainder mod 6 is 0. In this example, the number 30 is chosen. As will be explained below, the number 30 will be used as the value v in the pseudo modulus s. The prime numbers p and q are selected using the chosen number and a predetermined rule. In this example, the prime numbers p and q for the first two prime numbers greater than 30, i.e., p=31and q=37. In this case, the modulus, is

$$\begin{matrix}n = p \times q \\ = 31 \times 37 \\ = 1147\end{matrix}$$

The totient ϕ(n) is:

$$\begin{matrix}ϕ ( n ) = ( p - 1 ) ( q - 1 ) \\ = ( 31 - 1 ) ( 37 - 1 ) \\ = 1080\end{matrix}$$

The public and private exponents are derived using conventional RSA. The public exponent e is any integer greater than 1 and coprime with ϕ(n)=1080. In this example, e=17 is chosen. The private exponent d can be found using the extended Euclidean algorithm:

$$d = {e}^{- 1} ( mod ϕ ( n ) )$$

Given e=17 and ϕ(n)=1080 in this example, d=5401.

In this example, the value, is related to p (the lowest prime number) by:

$${f}_{i}^{T} ( p ) = p - ( p mod 6 )$$

where the index i=0002. The pseudo modulus s is obtained by combining i and v. For simplicity, the pseudo modulus s in this example is assumed to be the concatenation of i and v, which is 000230. The pseudo modulus s is substituted for the real modulus n is the public and private keys so the public key becomes (e, s) and the private key becomes (d, s).

The owner receives the private key from the TA and the public key is shared with others that want to communicate securely with the owner. To encrypt a message intended for the owner, the sender sends an encryption request to the TA including the plaintext message M, the public exponent e, and the pseudo modulus s The TA calculates the ciphered message C and returns the ciphered message C to the sender. The communication between the sender and TA is over a secure connection.

To encrypt the plaintext message M, the TA first needs to determine the real modulus n from the pseudo modulus s contained In the encryption request. The real modulus m is obtained by extracting v from s and applying a reverse transform function

$${f}_{i}^{R} ( v )$$

to v. As previously described, the TA uses a secret mapping between i and

$${f}_{i}^{R} ( v )$$

to determine the correct function to apply. In this example, the reverse transform function is given by:

$${f}_{i}^{R} ( v )$$

is given by:

$${f}_{i}^{R} ( v ) = \{ \begin{matrix}p = NextPrime ( v + 1 ) \\ q = NextPrime ( p + 1 )\end{matrix} \}$$

Given v=30, p and q are determined to be 31 and 37 respectively. The modulus n is then calculated by multiplying p and q to get 1147. Once n is obtained, the conventional RSA encryption is applied to encrypt the plaintext message M. To complete this example, the ciphered message C is given by:

$$C = {M}^{e} mod ( n )$$

Assuming that the message M=65, the ciphered message C=115.

A similar process is used to decrypt the ciphered message C. When the owner receives the encrypted message, the owner sends a decryption request to the TA including the ciphered message C, the private exponent d and the pseudo modulus s The TA calculates the plaintext message M and returns the plaintext message M to the owner. The communication between the owner and TA is over a secure connection.

To decrypt the ciphered message C, the TA first needs to determine the real modulus n from the pseudo modulus s contained In the encryption request. The real modulus n is obtained as previously described by extracting v from s and applying the reverse transform function

$${f}_{i}^{T} ( v )$$

to v. As described above, applying the reverse transform function yields n=1147. Once n is obtained, the conventional RSA encryption is applied to decrypt the ciphered message. To complete this example, the plaintext message M is given by:

$$M = {C}^{d} mod ( n )$$

Assuming that the ciphered message C=115, the plaintext message M is calculated to be 65.

Ladhe's Algorithm thwarts factorization attacks by eliminating the distribution of the real modulus n. Instead, the modulus n is encapsulated in the pseudo modulus S, which is made public. Without knowledge of the transform function, a malicious third party has no feasible way to determine n from S. But the number of potential transformations that can be applied to obscure n makes it virtually impossible to derive the modulus n especially when combined with regular key updates.

Also, by preventing factorization attacks, the life expectancy of RSA is extended without the need for longer keys, which would increase computational complexity and latency. Thus, Ladhe's Algorithm can help prevent the security framework of the Internet from being compromised, which could result is disastrous consequences.

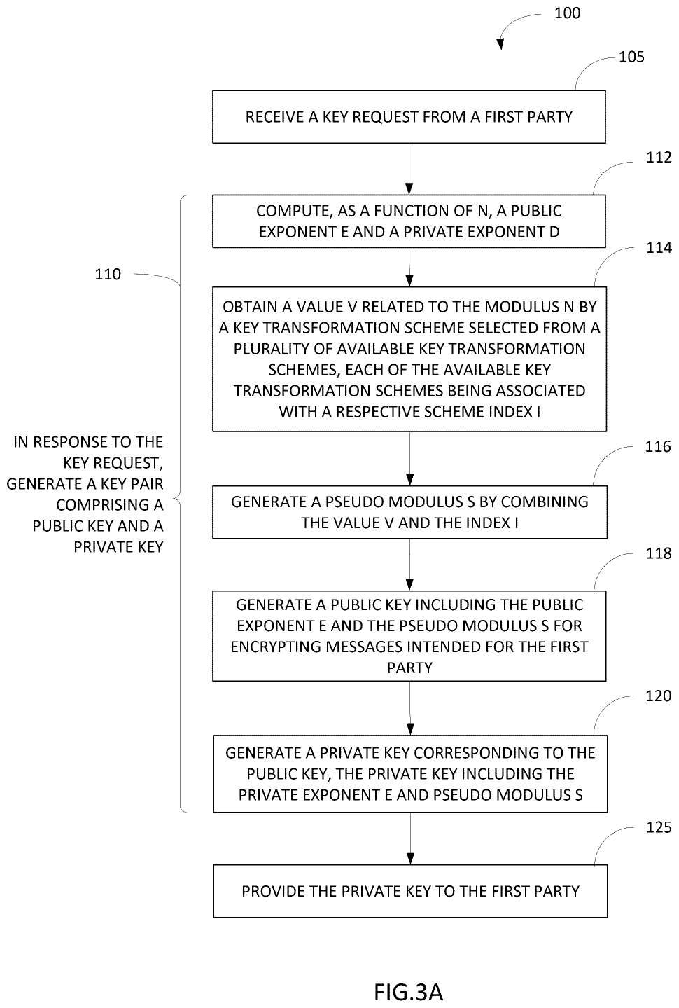

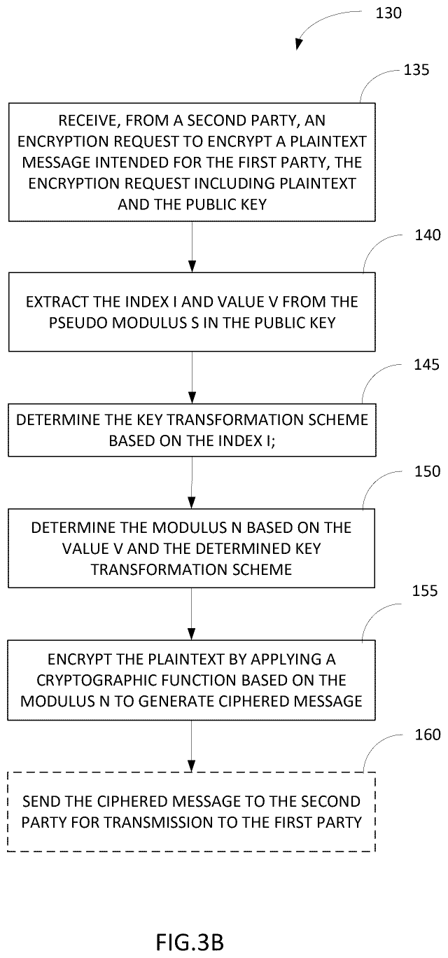

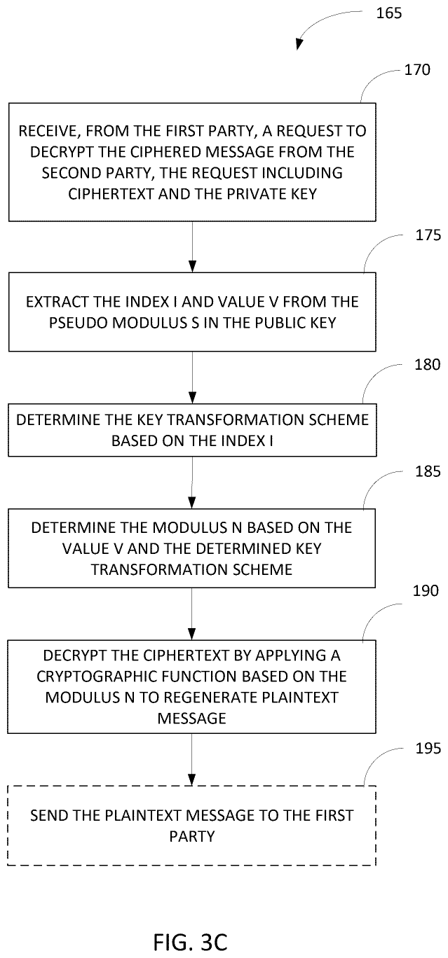

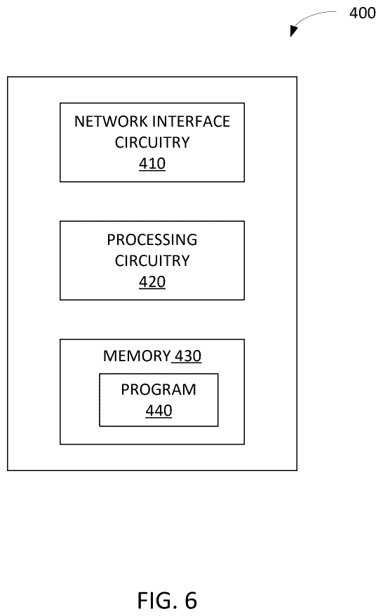

FIG. 3A illustrates a method 100 implemented in a computing device 400 (FIG. 6) for a trusted agent of generating and distributing cryptographic keys for an asymmetric cryptographic algorithm. The computing device 400 for the TA receives a key request from a first party (block 105). In response to the key request, the computing device 400 generates a key pair comprising a public key and a private key (block 110). The computing device 400 computes a modulus n as a function of two or more prime numbers (block 112). The computing device 400 obtains a value v related to the modulus n by a key transformation scheme selected from a plurality of available key transformation schemes (block 114). Each of the available key transformation schemes being associated with a respective scheme index i. The computing device 400 generates a pseudo modulus s by combining the value v and the index i. (block 116). The computing device 400 generates public key including the public exponent e and the pseudo modulus s (block 118). The public key is used for encrypting messages intended for the first party, i.e., the key owner. The computing device 400 generates a private key corresponding to the public key and including the private exponent e and pseudo modulus s (block 120). The computing device 400 provides the private key to the first party (block 125).

In some embodiments of method 100, the transformation scheme comprises one of a rule set comprising one or more rules to be applied to at least one of the prime numbers to generate the value v of the pseudo key, and wherein the index i indicates the rule set, a mathematical relation between one or more of the prime numbers and the value v, and wherein the index i indicates the mathematical relation, a function of one or more of the prime numbers, and wherein the index i indicates the function, a rule set comprising one or more rules to be applied to the modulus n to generate the value v of the pseudo key, and wherein the index i indicates the rule set, a mathematical relation between the modulus n and the value v, and wherein the index i indicates the mathematical relation, and a function of the modulus n, and wherein the index i indicates the function.

FIG. 3B illustrates a method 130 implemented in a computing device 400 for a TA of encrypting a plaintext message M. The computing device 400 for the TA receives, from a second party, an encryption request to encrypt a plaintext message intended for the first party, the encryption request including plaintext and the public key (block 135). The computing device 400 extracts the index i and value v from the pseudo modulus s in the public key (block 140) and determines the key transformation scheme based on the index i (block 145). The computing device 400 determines the modulus n based on the value v and the determined key transformation scheme (block 150) and encrypts the plaintext by applying a cryptographic function based on the modulus n to generate ciphered message (block 155). In some embodiments of method 100, the computing device 400 further sends the ciphered message to the second party for transmission to the first party (block 160).

FIG. 3C illustrates a method 165 implemented in a computing device 400 for a TA of decrypting a ciphered message. The computing device 400 for the TA receives, from the first party, a request to decrypt the ciphered message from the second party, the request including ciphertext and the private key (block 170). The computing device 400 extracts the index i and value v from the pseudo modulus s in the public key (block 175). The computing device 400 determines the key transformation scheme based on the index I (block 180) and determines the modulus n based on the value v and the determined key transformation scheme (block 185). The computing device 400 then decrypts the ciphertext by applying a cryptographic function based on the modulus n to regenerate plaintext message (block 190). In some embodiments of method 100, the computing device 400 further sends the plaintext message to the first party (block 195)

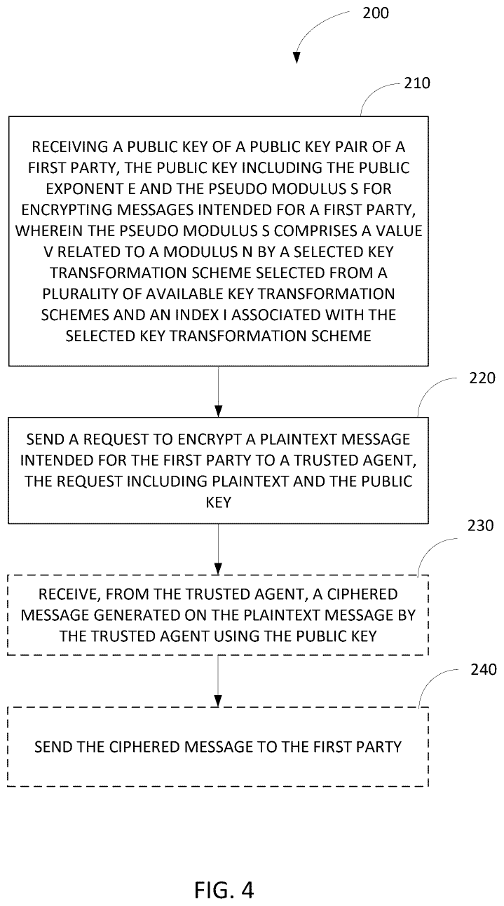

FIG. 4 illustrates a method 200 implemented by a computing device 400 of encrypting a plaintext message. The computing device 400 receives a public key of a public key pair of a first party (block 210). The public key including the public exponent e and the pseudo modulus s for encrypting messages intended for a first party. The pseudo modulus s comprises a value v related to a modulus n by a selected key transformation scheme selected from a plurality of available key transformation schemes and an index i associated with the selected key transformation scheme. The computing device 400 sends a request to encrypt a plaintext message intended for the first party to a trusted agent, the request including plaintext and the public key (block 220).

In some embodiments of method 200, the computing device 400 further receives, from the trusted agent, a ciphered message generated on the plaintext message by the trusted agent using the public key (block 230) and sends the ciphered message to the first party (block 240).

In some embodiments of method 200, the transformation scheme comprises one of a rule set comprising one or more rules to be applied to at least one of the prime numbers to generate the value v of the pseudo key, and wherein the index i indicates the rule set, a mathematical relation between one or more of the prime numbers and the value v, and wherein the index i indicates the mathematical relation, a function of one or more of the prime numbers, and wherein the index i indicates the function, a rule set comprising one or more rules to be applied to the modulus n to generate the value v of the pseudo key, and wherein the index i indicates the rule set, a mathematical relation between the modulus n and the value v, and wherein the index i indicates the mathematical relation, and a function of the modulus n, and wherein the index i indicates the function.

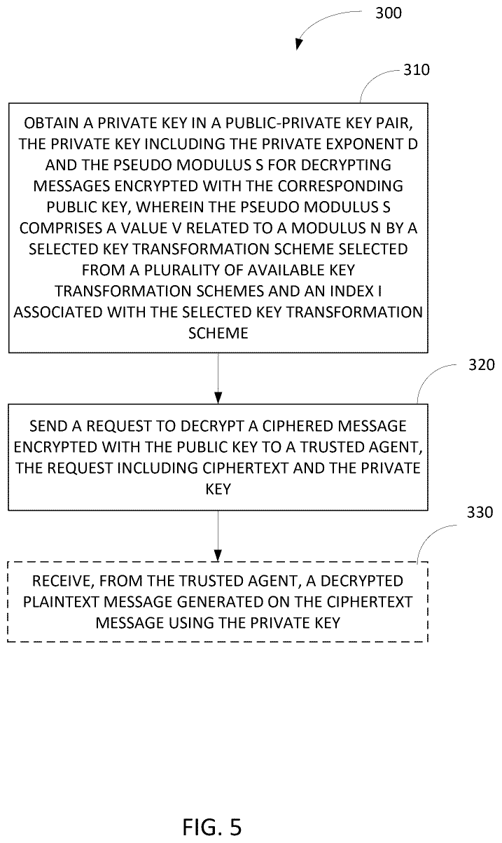

FIG. 5 illustrates a method 300 implemented by a computing device 400 of decrypting a ciphered message. The computing device 400 obtains a private key in a public-private key pair (block 310). The private key including the private exponent d and the pseudo modulus s for decrypting messages encrypted with the corresponding public key. The pseudo modulus s comprises a value v related to a modulus n by a selected key transformation scheme selected from a plurality of available key transformation schemes and an index i associated with the selected key transformation scheme. The computing device 400 further sends a request to decrypt a ciphered message encrypted with the public key to a trusted agent (block 320). The request includes ciphertext and the private key.

In some embodiments of method 300, the computing device 400 further receives, from the trusted agent, a decrypted plaintext message generated on the ciphertext message using the private key (block 330).

In some embodiments of method 300, the transformation scheme comprises one of a rule set comprising one or more rules to be applied to at least one of the prime numbers to generate the value v of the pseudo key, and wherein the index i indicates the rule set, a mathematical relation between one or more of the prime numbers and the value v, and wherein the index i indicates the mathematical relation, a function of one or more of the prime numbers, and wherein the index i indicates the function, a rule set comprising one or more rules to be applied to the modulus n to generate the value v of the pseudo key, and wherein the index i indicates the rule set, a mathematical relation between the modulus n and the value v, and wherein the index i indicates the mathematical relation, and a function of the modulus n, and wherein the index i indicates the function.

FIG. 6 illustrates the main functional components of a computing device 400 for implementing the cryptographic algorithms as herein described. The computing device 400 generally comprises network interface circuitry 410, processing circuitry 420, and memory 440.

The network interface circuitry 410 comprises a network adapter for coupling the computing device 400 to a communication network to enable communication with remote devices. The network adapter may for example, comprise a wired interface (e.g., Ethernet interface), optical interface (e.g., Synchronous Optical Network (SONET)), or wireless interface (e.g., Wireless fidelity (WiFi)).

The processing circuitry 420 comprises one or more microprocessors, hardware, firmware, or a combination thereof. The processing circuitry 420 in one embodiment is configured to implement the cryptographic algorithms herein described.

Memory 430 comprises both volatile and non-volatile memory for storing computer program code and data needed by the processing circuit 420 for operation. Memory 430 may comprise any tangible, non-transitory computer-readable storage medium for storing data including electronic, magnetic, optical, electromagnetic, or semiconductor data storage. Memory 430 stores a computer program 440 comprising executable instructions that configure the processing circuit 420 to implement the cryptographic algorithms herein described. A computer program 440 in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 440 for configuring the processing circuitry 420 as herein described may be stored in a removable memory, such as a portable compact disc, portable digital video disc, or other removable media. The computer program 440 may also be embodied in a carrier such as an electronic signal, optical signal, radio signal, or computer readable storage medium.

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

The present invention may, of course, be carried out in other specific ways than those herein set forth without departing from the spirit and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of concealing cryptographic keys for an asymmetric cryptographic algorithm, the method comprising:
receiving a key request from a first party;
in response to the key request, generating a key pair comprising a public key and a private key by:
computing a modulus n as a function of two or more prime numbers;
computing, as a function of n, a public exponent e and a private exponent d;
obtaining a value v related to the modulus n by a key transformation scheme selected from a plurality of available key transformation schemes, each of the available key transformation schemes being associated with a respective scheme index i;
generating a pseudo modulus s by combining the value v and the index i;
generating a public key including the public exponent e and the pseudo modulus s for encrypting messages intended for the first party; and
generating a private key corresponding to the public key, the private key including the private exponent e and pseudo modulus s.
providing the private key to the first party.

2. The method of claim 1, further comprising:
receiving, from a second party, an encryption request to encrypt a plaintext message intended for the first party, the encryption request including plaintext and the public key;
extracting the index i and value v from the pseudo modulus s in the public key;
determining the key transformation scheme based on the index i;
determining the modulus n based on the value v and the determined key transformation scheme; and
encrypting the plaintext by applying a cryptographic function based on the modulus n to generate ciphered message.

3. The method of claim 2 further comprising sending the ciphered message to the second party for transmission to the first party.

4. The method of claim 3 further comprising:
receiving, from the first party, a request to decrypt the ciphered message from the second party, the request including ciphertext and the private key;
extracting the index i and value v from the pseudo modulus s in the public key;
determining the key transformation scheme based on the index i;
determining the modulus n based on the value v and the determined key transformation scheme; and
decrypting the ciphertext by applying a cryptographic function based on the modulus n to regenerate plaintext message.

5. The method of claim 4 further comprising sending the plaintext message to the first party.

6. The method of claim 1, wherein the transformation scheme comprises one of:
a rule set comprising one or more rules to be applied to at least one of the prime numbers to generate the value v of the pseudo key, and wherein the index i indicates the rule set;
a mathematical relation between one or more of the prime numbers and the value v, and wherein the index i indicates the mathematical relation;
a function of one or more of the prime numbers, and wherein the index i indicates the function;
a rule set comprising one or more rules to be applied to the modulus n to generate the value v of the pseudo key, and wherein the index i indicates the rule set;
a mathematical relation between the modulus n and the value v, and wherein the index i indicates the mathematical relation; and
a function of the modulus n, and wherein the index i indicates the function.

7. A method of encrypting a plaintext message, the method comprising:
receiving a public key of a public key pair of a first party, the public key including the public exponent e and the pseudo modulus s for encrypting messages intended for a first party, wherein the pseudo modulus s comprises a value v related to a modulus n by a selected key transformation scheme selected from a plurality of available key transformation schemes and an index i associated with the selected key transformation scheme; and
sending a request to encrypt a plaintext message intended for the first party to a trusted agent, the request including plaintext and the public key.

8. The method of claim 7, further comprising:
receiving, from the trusted agent, a ciphered message generated on the plaintext message by the trusted agent using the public key; and
sending the ciphered message to the first party.

9. The method of claim 7, wherein the transformation scheme comprises one of:
a rule set comprising one or more rules to be applied to at least one of the prime numbers to generate the value v of the pseudo key, and wherein the index i indicates the rule set;
a mathematical relation between one or more of the prime numbers and the value v, and wherein the index i indicates the mathematical relation;
a function of one or more of the prime numbers, and wherein the index i indicates the function;
a rule set comprising one or more rules to be applied to the modulus n to generate the value v of the pseudo key, and wherein the index i indicates the rule set;
a mathematical relation between the modulus n and the value v, and wherein the index i indicates the mathematical relation; and
a function of the modulus n, and wherein the index i indicates the function.

10. A method implemented by a computing device of a first party of decrypting a ciphered message, the method comprising:
obtaining a private key in a public-private key pair, the private key including the private exponent d and the pseudo modulus s for decrypting messages encrypted with the corresponding public key, wherein the pseudo modulus s comprises a value v related to a modulus n by a selected key transformation scheme selected from a plurality of available key transformation schemes and an index i associated with the selected key transformation scheme; and
sending a request to decrypt a ciphered message encrypted with the public key to a trusted agent, the request including ciphertext and the private key.

11. The method of claim 10, further comprising
receiving, from the trusted agent, a decrypted plaintext message generated on the ciphertext message using the private key.

12. The method of claim 10, wherein the transformation scheme comprises one of:
a rule set comprising one or more rules to be applied to at least one of the prime numbers to generate the value v of the pseudo key, and wherein the index i indicates the rule set;
a mathematical relation between one or more of the prime numbers and the value v, and wherein the index i indicates the mathematical relation;
a function of one or more of the prime numbers, and wherein the index i indicates the function;
a rule set comprising one or more rules to be applied to the modulus n to generate the value v of the pseudo key, and wherein the index i indicates the rule set;
a mathematical relation between the modulus n and the value v, and wherein the index i indicates the mathematical relation; and
a function of the modulus n, and wherein the index i indicates the function.

13. A computing device for concealing cryptographic keys for an asymmetric cryptographic algorithm, the computing device comprising:
network interface circuitry for coupling the computing device to a communication network; and
processing circuitry configured to:
receive a key request from a first party;
in response to the key request, generate a key pair comprising a public key and a private key by:
compute a modulus n as a function of two or more prime numbers;
compute, as a function of n, a public exponent e and a private exponent d;
obtain a value v related to the modulus n by a key transformation scheme selected from a plurality of available key transformation schemes, each of the available key transformation schemes being associated with a respective scheme index i;
generate a pseudo modulus s by combining the value v and the index i;
generate a public key including the public exponent e and the pseudo modulus s for encrypting messages intended for the first party;
generate a private key corresponding to the public key, the private key including the private exponent e and pseudo modulus s; and
provide the private key to the first party.

14. The computing device of claim 13, wherein the processing circuit is further configured to:
receive, from a second party, an encryption request to encrypt a plaintext message intended for the first party, the encryption request including plaintext and the public key;
extract the index i and value v from the pseudo modulus s in the public key;
determine the key transformation scheme based on the index i;
determine the modulus n based on the value v and the determined key transformation scheme; and
encrypt the plaintext by applying a cryptographic function based on the modulus n to generate ciphered message.

15. The computing device of claim 13 wherein the processing circuit is further configured to send the ciphered message to the second party for transmission to the first party.

16. The computing device of claim 15, wherein the processing circuit is further configured to:
receive, from the first party, a request to decrypt the ciphered message from the second party, the request including ciphertext and the private key;
extract the index i and value v from the pseudo modulus s in the public key;
determine the key transformation scheme based on the index i;
determine the modulus n based on the value v and the determined key transformation scheme; and
decrypt the ciphertext by applying a cryptographic function based on the modulus n to regenerate plaintext message.

17. The method of claim 13, wherein the transformation scheme comprises one of:
a rule set comprising one or more rules to be applied to at least one of the prime numbers to generate the value v of the pseudo key, and wherein the index i indicates the rule set;
a mathematical relation between one or more of the prime numbers and the value v, and wherein the index i indicates the mathematical relation;
a function of one or more of the prime numbers, and wherein the index i indicates the function;
a rule set comprising one or more rules to be applied to the modulus n to generate the value v of the pseudo key, and wherein the index i indicates the rule set;
a mathematical relation between the modulus n and the value v, and wherein the index i indicates the mathematical relation; and
a function of the modulus n, and wherein the index i indicates the function.

18. A computing device for encrypting a plaintext message, the computing device comprising:
network interface circuitry for coupling the computing device to a communication network; and
processing circuitry configured to:
receive a public key of a public key pair of a first party, the public key including the public exponent e and the pseudo modulus s for encrypting messages intended for a first party, wherein the pseudo modulus s comprises a value v related to a modulus n by a selected key transformation scheme selected from a plurality of available key transformation schemes and an index i associated with the selected key transformation scheme; and
send a request to encrypt a plaintext message intended for the first party to a trusted agent, the request including plaintext and the public key.

19. The computing device of claim 18, wherein the processing circuit is further configured to:
receive, from the trusted agent, a ciphered message generated on the plaintext message by the trusted agent using the public key; and
send the ciphered message to the first party.

20. The computing device of claim 18, wherein the transformation scheme comprises one of:
a rule set comprising one or more rules to be applied to at least one of the prime numbers to generate the value v of the pseudo key, and wherein the index i indicates the rule set;
a mathematical relation between one or more of the prime numbers and the value v, and wherein the index i indicates the mathematical relation;
a function of one or more of the prime numbers, and wherein the index i indicates the function;
a rule set comprising one or more rules to be applied to the modulus n to generate the value v of the pseudo key, and wherein the index i indicates the rule set;
a mathematical relation between the modulus n and the value v, and wherein the index i indicates the mathematical relation; and
a function of the modulus n, and wherein the index i indicates the function.

21. A computing device implemented by a first party of decrypting a ciphered message, the computing device comprising:
network interface circuitry for coupling the computing device to a communication network; and
processing circuitry configured to:
obtain a private key in a public-private key pair, the private key including the private exponent d and the pseudo modulus s for decrypting messages encrypted with the corresponding public key, wherein the pseudo modulus s comprises a value v related to a modulus n by a selected key transformation scheme selected from a plurality of available key transformation schemes and an index i associated with the selected key transformation scheme; and
send a request to decrypt a ciphered message encrypted with the public key to a trusted agent, the request including ciphertext and the private key.

22. The computing device of claim 21, wherein the processing circuit is further configured to receive, from the trusted agent, a decrypted plaintext message generated on the ciphertext message using the private key.

23. The computing device of claim 21, wherein the transformation scheme comprises one of:
a rule set comprising one or more rules to be applied to at least one of the prime numbers to generate the value v of the pseudo key, and wherein the index i indicates the rule set;
a mathematical relation between one or more of the prime numbers and the value v, and wherein the index i indicates the mathematical relation;
a function of one or more of the prime numbers, and wherein the index i indicates the function;
a rule set comprising one or more rules to be applied to the modulus n to generate the value v of the pseudo key, and wherein the index i indicates the rule set;
a mathematical relation between the modulus n and the value v, and wherein the index i indicates the mathematical relation; and
a function of the modulus n, and wherein the index i indicates the function.
